(19) United States
(12) Patent Application Publication
(10) Pub. No.: US 2009/0210402 A1
(43) Pub. Date: Aug. 20, 2009

(54) SYSTEM AND METHOD FOR CONTEXTUAL ASSOCIATION DISCOVERY TO CONCEPTUALIZE USER QUERY

(75) Inventors: Seung-yeol Yoo, Suwon-si (KR); Kyung-sub Min, Seoul (KR)

Correspondence Address: MCNEELY BODENDORF LLP, P.O. BOX 34175, WASHINGTON, DC, 20043, US

(73) Assignee: Samsung Electronics Co. LTD., Suwon-si (KR)

(21) Appl. No.: 12/370,832

(22) Filed: Feb. 13, 2009

(30) Foreign Application Priority Data
Feb. 18, 2008 (KR) 2008-14459

(51) Int. Cl. G06F 17/30

(52) U.S. Cl. 707/4; 707/E17.014

(57) ABSTRACT

A method and system for contextual association discovery to conceptualize a user query. The system includes a user input unit receiving an input of a user query from a user, an attribute extraction unit extracting one or more attributes that materialize the meaning of the input query, a related attribute selection unit selecting one or more related attributes among the extracted attributes, and a content classification unit classifying specified content in accordance with the selected related attributes and the query.

### CROSS-REFERENCE TO RELATED APPLICATION

This application claims all benefits accruing under 35 U.S.C. §119 from Korean Patent Application No. 2008-14459 filed on Feb. 18, 2008 in the Korean Intellectual Property Office, the disclosure of which is incorporated herein by reference.

### BACKGROUND OF THE INVENTION

1. Field of the Invention

Aspects of the present invention relate to a method and system to conceptualize a user query via contextual association discovery, and more particularly, to a method and system for contextual association discovery, which can conceptualize a user query based on content summarization in searching documents.

2. Description of the Related Art

As the capacity of storage media continues to increase, the quantities of content that can be stored in the storage media are increasing in geometric progression. In addition, with the development of wired and wireless communication technologies, a user can access large quantities of content existing in web sites throughout the world and in repositories of respective servers, through a search engine.

Accordingly, in searching the large quantities of content online or offline, a user attempts to search the content by inputting a simple user query. However, since the input of such a simple user query involves ambiguity of the content itself, the search engine may retrieve content that corresponds to a user search intention or content that is irrelevant to the user search intention.

On the other hand, a user may input his/her search intention to the search engine through a user query. However, since the user cannot clearly know the object to be searched or the search object is not clearly conceptualized, it is not easy to select a proper user query. In addition, the user is required to understand quickly the content information of the large quantities of content to be searched through a simple query, or to clearly set an object to be searched through a continuous interaction with the search engine. Accordingly, there is a need for a method and system capable of classifying and providing content related to a user query intention or a conceptualized vocabulary along with conceptualizing a user query based on the user query.

### SUMMARY OF THE INVENTION

Aspects of the present invention provide a method and system for contextual association discovery, which can conceptualize a user query based on content summarization of accessible content.

Additional aspects of the present invention provide a method and system for contextual association discovery, which can easily extract content having a high correlation by classifying accessible content in accordance with a conceptualized vocabulary as conceptualizing a user query.

Still further aspects of the present invention provide a method and system for contextual association discovery, which can permit a user to easily materialize user search intention or the concept of a query through an input of a user query and a selection of a related attribute.

According to an aspect of the present invention, a system to conceptualize a user query via contextual association discovery is provided. The system includes a user input unit to receive an input of a user query from a user; an attribute extraction unit to extract one or more attributes indicative of the meaning of the input query; a related attribute selection unit to select one or more related attributes from the extracted attributes; and a content classification unit to classify specified content based on the selected related attributes and the query.

According to another aspect of the present invention, a method of contextual association discovery to conceptualize a user query is provided. The method includes receiving an input of a user query from a user; extracting one or more attributes indicative of a meaning of the input query; selecting one or more related attributes from the extracted attributes; and classifying specified content based on the selected related attributes and the query.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a block diagram illustrating a system to conceptualize a user query via contextual association discovery according to an example embodiment of the present invention;

FIG. 2 is a block diagram illustrating a content summarization unit in a system to conceptualize a user query via contextual association discovery according to an example embodiment of the present invention;

FIG. 3 is an exemplary view explaining the operation of a system for contextual association discovery to conceptualize a user query according to an example embodiment of the present invention;

FIG. 4 is a view explaining information derived from respective layers in FIG. 3;

FIG. 5 is an exemplary view explaining the operation of a system for contextual association discovery to conceptualize a user query according to another example embodiment of the present invention;

FIG. 6 is a view explaining information derived from respective layers in FIG. 5; and

FIG. 7 is a flowchart illustrating a process of contextual association discovery to conceptualize a user query according to an example embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Aspects of the present invention will be described herein with reference to the accompanying drawings illustrating block diagrams and flowcharts to explain a method and system to conceptualize a user query via contextual association discovery according to example embodiments of the present invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, implement the operations specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instructions to implement the operations specified in the flowchart block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus implement the operations specified in the flowchart block or blocks.

Also, each block of the flowchart illustrations may represent a module, segment, or portion of code, which comprises one or more executable instructions for implementing the specified logical operation(s). It should also be noted that in some alternative implementations, the operations noted in the blocks may occur out of order. For example, two blocks shown in succession may in fact be executed substantially concurrently or the blocks may sometimes be executed in the reverse order, depending upon the functionality involved.

The term “unit”, as used herein, indicates, but is not limited to, a software or hardware component, such as a Field Programmable Gate Array (FPGA) or Application Specific Integrated Circuit (ASIC), which performs certain tasks. A unit may advantageously be configured to reside on the addressable storage medium and configured to execute on one or more processors. Thus, a unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and units may be combined into fewer components and units or further separated into additional components and units.

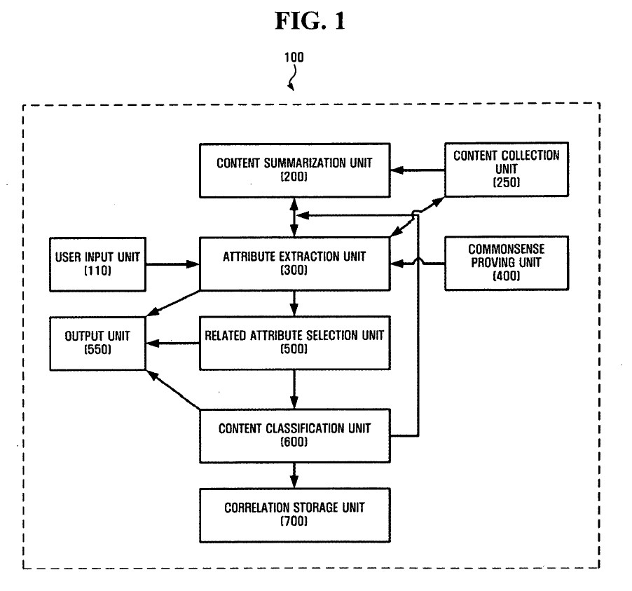

FIG. 1 shows a system 100 to conceptualize a user query via contextual association discovery according to an example embodiment of the present invention. The system 100 includes a user input unit 110, a content collection unit 250, a content summarization unit 200, a commonsense providing unit 400, an attribute extraction unit 300, a related attribute selection unit 500, a content classification unit 600, an output unit 550, and a correlation storage unit 700. These units need not be implemented in the same device. For example, some of the units may be implemented in a client device, such as a desktop computer, laptop computer, mobile phone, personal digital assistant, personal entertainment device, or the like. Others of the units may be implemented in, for example, a server or other network device to receive queries and/or store content.

The term “content” as used herein refers to various kinds of objects of which content information can be summarized. For example, if the content is a document, the content information can be summarized by extracting syntax information of the document. This process can also be applied to web documents of accessible web sites collected by the content collection unit 250 through a wired or wireless network. If the content is a moving image or an image, the content information can be summarized by extracting metadata, caption information, cast information, and the like, from the content. As described above, the content may include all accessible objects from which the content information can be extracted.

The user input unit 110 receives an input of a user query. The user input unit 110 serves as an interface to transfer the user query inputted from a user to the system 100. For example, the user inputs the query using an input device (not illustrated), such as a keyboard, a mouse, a touch screen, a pen, a microphone, and the like, and the user input unit 110 receives and transfers the corresponding input information to the system 100.

The user input unit 110 may also receive user input information from a client device used by the user, and transmit the received user input information to the system for contextual association discovery according to the present invention. The user input unit 110 may receive the user input information through a network based on the Internet, the Intranet, a virtual private network (VPN), and the like, or through a network such as a local area network (LAN), a wide area network (WAN), and the like. As described above, the client device may be, for example, a desktop computer, laptop computer, mobile phone, personal digital assistant, or a personal entertainment device.

The output unit 550 displays the information outputted from the attribute extraction unit 300, the related attribute selection unit 500, the content classification unit 600, and the like. The output unit 550 visually shows the information to the user through a display device, such as a cathode-ray tube (CRT), a liquid crystal display (LCD), a plasma display panel (PDP), an organic light emitting diode (OLED), an electro chromic display (ECD), and the like.

The content collection unit 250 collects content to be summarized by the content summarization unit 200. The content collection unit 250 collects content stored in a certain repository or a user device, such as a computer, a portable phone, a PDA, and the like. The content collection unit 250 collects diverse accessible content through a wired or wireless network. The content collection unit 250 stores the collected content in a storage unit (not shown), or stores only link information of the content that can be accessed through the wired or wireless network. The storage unit (not shown) may be located in a server or a client device.

The content summarization unit 200 summarizes the content in structure. The content summarization unit 200 analyzes the structure of the content by extracting a syntax included in the content. For example, the content summarization unit 200 summarizes the content in structure through a syntax process, such as syntax tagging, phrase chunking, segmentation, and the like.

The attribute extraction unit 300 extracts attributes for the user query or the selected vocabulary. The attribute indicates a word obtained by further conceptualizing or materializing the meaning of the corresponding query or the selected vocabulary. For example, the attribute extraction unit 300 receives and extracts dictionary information of the query or defined meaning information from the commonsense providing unit 400 to extract the dictionary information or the defined meaning information as the attribute. In another example, the attribute extraction may be performed based on summarized content from the content summarization unit. As still another example, the attribute extraction may be performed by directly grasping syntax information from a specified content set or a content subset. However, the attribute extraction is not limited to the above-described processes, and may be performed by any process of extracting a related word. In extracting the attribute, priority orders may be given to the above-described processes, and the attributes may be extracted in accordance with the priority orders of the above-described methods.

The commonsense providing unit 400 may provide definition information of general words or wordings to the attribute extraction unit 300, such as a specified dictionary, an encyclopedia, and the like. The commonsense providing unit 400 may limit the attribute extraction of the attribute extraction unit 300 to within a predetermined range by providing generally used definition or meaning information with respect to the query initially inputted by a user.

For example, if the user inputs a wording “Java platform for web service” as an initial query, the user query need not be actually fixed to one wording, but may be separated into six vocabularies, such as “java, platform, web, service, java platform, web service”. In this case, the commonsense providing unit 400 extracts attributes for the six separated vocabularies, and this causes the attribute extraction of the six separated vocabularies to become relatively simple.

With respect to the six separated attributes, the attribute extraction unit 300 may extract related documents from the content summarization unit 200 and extract attributes from the extracted documents. In this case, respective documents may be extracted for the separated vocabularies, and a plurality of attributes may be extracted from the extracted documents, so that the attributes more than expected may be extracted. Accordingly, in the case where the user query is lengthened, the attribute extraction through the definition information provided from the commonsense providing unit 400 may relatively reduce the system load.

The related attribute selection unit 500 selects an attribute that is judged to have high correlations among the extracted attributes. For example, the related attribute selection unit 500 examines the correlations between an attribute having a high correlation and an attribute extracted as a result of structural analysis of various accessible content among the extracted attributes. The related attribute selection unit 500 then generates quantitative values for the correlations, arranges the extracted attributes based on their order, and selects one or more of the arranged attributes as the related attributes. The related attributes may be interactively selected by the user, or several attributes having high correlations may be automatically selected by the system.

The content classification unit 600 classifies a specified content set based on the selected related attributes. The content classification unit 600 selects the specified content set, and classifies the content in the selected content set based on the respective related attributes. Accordingly, by classifying the content in accordance with the related attributes, respective content sets are generated with respect to one or more related attributes.

The content classification unit 600 can perform the content classification in various methods. For example, the content classification unit 600 may adopt a vector model that classifies the content by making a numerical representation of the similarity among the wordings appearing in the content of the specified content set, between the related attributes newly selected and the related attributes previously selected.

As described above, according to an example embodiment of the present invention, the attributes for conceptualizing the user query inputted by the user are extracted, and the related attributes are selected. By classifying the content in accordance with the selected related attributes, the content can be automatically classified in accordance with the query conceptualization. Also, through the addition of the related attributes, a specified conceptual model that matches the user query intention can be generated.

As shown in FIG. 1, the system 100 may further include a correlation storage unit 700. The correlation storage unit 700 stores specified conceptual models generated by the system according to an embodiment of the present invention. The conceptual models may be stored based on the content set information classified according to the query and the selected related attributes as the contextual association information. The contextual association information may include hierarchical structure information generated in a similar manner to a tree structure.

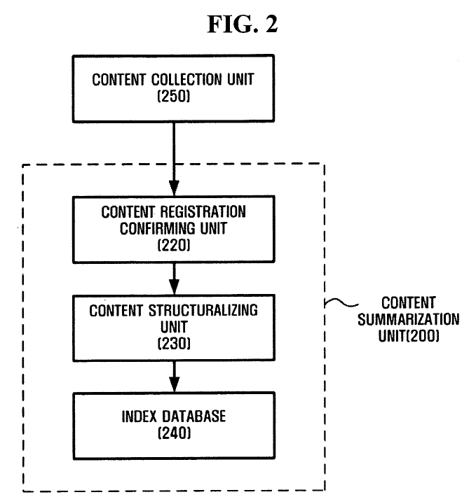

FIG. 2 shows the content summarization unit 200 according to an example embodiment of the present invention. As shown in FIG. 2, the content summarization unit 200 receives the content from the content collection unit 250, and summarizes the received content. The content summarization unit 200 includes a content registration confirming unit 220, a content structuralizing unit 230, and an index database 240. The content summarization unit 200 may be separated from the system 100, or may store content summarization information preprocessed by the content summarization unit 200 in a storage unit (not shown) before the system 100 operates.

The content registration confirming unit 220 confirms whether the content is duplicate content before the content summarization is performed. The content registration confirming unit 220 confirms the duplicate content by comparing the content summarization information or content data with that of other content already processed. If the content is duplicate content, the content registration confirming unit 220 indicates that the content is duplicate content, and omits the content summarization or processes the content summarization information in the same manner as that already processed.

The content structuralizing unit 230 extracts and structurally analyzes the syntax information included in the content. The content structuralizing unit 230 structurally summarizes the content though a language process, such as syntax tagging, phrase chunking, segmentation, and the like.

Syntax tagging disassembles a sentence included in the content into a plurality of constituent elements through a syntax analysis, and determines the structure of the sentence by analyzing hierarchy relations among the disassembled constituent elements. Through syntax tagging, it is possible to classify the structure of the whole document, for example, chapters, sections, paragraphs, and the like, included in the content.

Phrase chunking extracts the respective constituent elements when the structure of the sentence is analyzed. Through phrase chunking, words and wordings used in the whole document can be extracted.

Segmentation structuralizes the whole sentence included in the content. The structuralizing of the whole sentence summarizes the contents of the document included in the content based on the number of appearances of respective words and their locations in the document. Accordingly, the content can be summarized by structuralizing the documents included in the content through the segmentation.

The index database 240 structurally arranges and stores the content in accordance with the content summarization. With respect to the content, the index database 240 stores indexes of words summarized by the document summarization unit 200. The index indicates the number of appearances of a specified word or a vocabulary and the location of the word. According to aspects of the present invention, not only the number of appearances of a specified word or vocabulary but also information on the location of the word in the content may be included in the index.

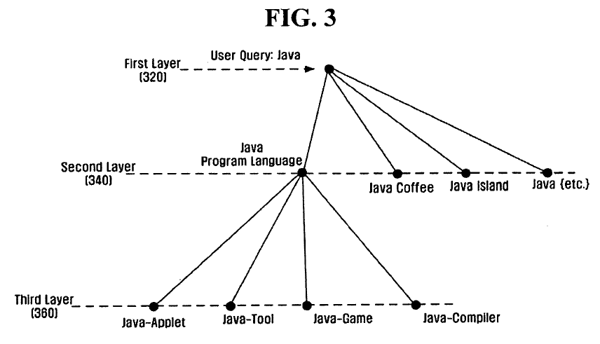

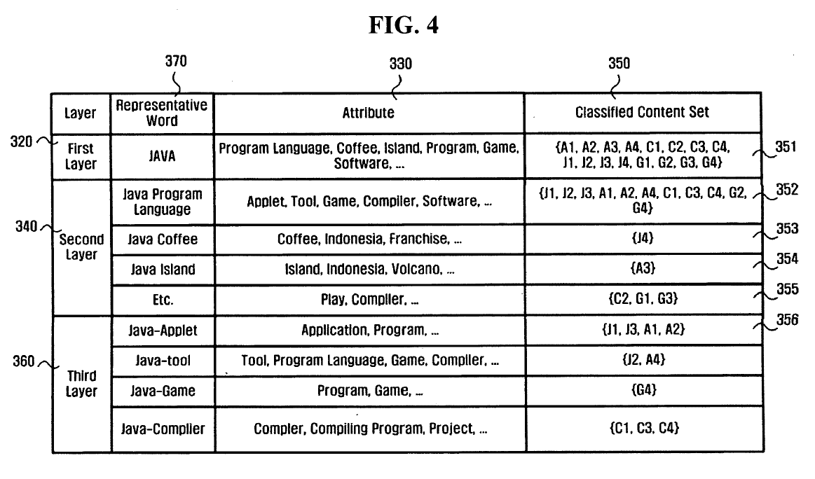

FIG. 3 shows the operation of the system 100 according to an example embodiment of the present invention, and FIG. 4 is a view explaining information derived from respective layers in FIG. 3. In the example shown in FIGS. 3 and 4, the user inputs a word “Java” as the user query. The user input unit 110 transmits the word “Java” to the attribute extraction unit 200, and the attribute extraction unit 200 extracts an attribute for the input word “Java”.

In a content search according to an example embodiment of the present invention, each step from an upper node to a lower node may be called a “layer”. Accordingly, the step of extracting a content set through an initial user query may be called a first layer. If another content set is extracted through the selection of a related attribute of the initial user query, the other content set may be called a second layer. As described above, as the number of layers becomes large, the related attributes are continuously added thereto, so that the user query can be conceptualized or materialized.

The attribute extraction unit 200 may request definition information of the word “Java” to the commonsense providing unit 400, and the commonsense providing unit 400 may provide the definition information of the word “Java”.

For example, using a dictionary provided in the commonsense providing unit 400, the definition of the wording “Java” is divided into three following wordings which can be arranged with three definition sentences.

(1) Java (Programming language): (n) a platform-independent object-oriented programming language)

(2) Java (coffee): (n) a beverage consisting of an infusion of ground coffee beans (“he ordered a cup of coffee”)

(3) Java (Island): (n) an island in Indonesia to the south of Borneo; one of the world's most densely populated regions

Accordingly, with respect to the word “Java”, the attribute extraction unit 200 extracts attributes 330, such as {Program Language, Coffee, Island, . . . }, through the word definition provided from the commonsense providing unit 400. The attributes 330 refer to all wordings related to the user query “Java”, and thus all words in the three definition sentences of the “Java” as defined above may be attribute candidates.

With respect to the user query “Java”, the content summarization unit 200 extracts a content set 350 composed of Java-related content using a general search engine or the index database 240, and provides the content set to the attribute extraction unit 200. For example, as shown in FIG. 4, Java-related content may be extracted as a first content set 351 that is {A1, A2, A3, A4, C1, C2, C3, C4, J1, J2, J3, J4, G1, G2, G3, G4}.

As another example of attribute extraction, the attribute extraction unit 200 extracts attributes from the content set 350 currently extracted. For example, with respect to the user query “Java”, the attribute extraction unit 200 extracts the attributes 330 by structurally analyzing the contents of the first content set 351 that is {A1, A2, A3, A4, C1, C2, C3, C4, J1, J2, J3, J4, G1, G2, G3, G4}. The attribute extraction unit 200 may also extract the attributes 330 by receiving the content summarization information of the content in the first content set from the index database 240 of the content summarization unit 200.

As described above, with respect to the user query “Java”, the attribute extraction unit 200 extracts one or more attributes 330, such as {Program Language, Coffee, Island, . . . }, and the related attribute selection unit 500 selects the related attributes among the extracted attributes. The related attribute indicates an attribute that conceptually materializes the meaning of the user query among the extracted attributes. The related attribute may also indicate an attribute that conceptualizes the user query to match the user intention. Accordingly, the related attributes form a subset of one or more attributes. For example, among the attributes in {Program Language, Coffee, Island, . . . }, {Program Language, Coffee} may be selected as the related attributes.

Accordingly, the related attributes may be selected among the extracted attributes so as to more concretely limit the user query or to characterize the user query intention. One or more related attributes may be selected by the user or may be automatically selected among one or more attributes of a high order by the system according to an embodiment of the present invention.

For example, as shown in FIG. 3, with respect to “Java”, “Program Language”, “Coffee”, and “Island” may be selected as the related attributes. In this case, there still exists content that is classified as others “Etc” since the association with the related attribute is below a threshold value although the content includes the word “Java” with a specified correlation with “Java”.

According to other aspects of the present invention, the attributes may be arranged in alphabetical or consonantal order or in the order of their association with the query or representative words. Various correlations, such as the number of appearances of the respective attributes, weight values of the respective attributes, associations with other attributes, and the like, may also be examined and numerically represented from the content set corresponding to the quantitative analysis of the correlations. The representative word indicates a vocabulary presented by conceptualizing the user query in the current layer. Accordingly, when the user inputs a query in the first layer, the input query becomes the representative word, while in the second layer, representative words that synthesize the query and the respective related attributes are generated.

If the related attributes are selected, the content classification unit 600 classifies the content based on the respective related attributes. For example, “Program Language”, which is one of the related attributes, may be referred to as a representative word “Java Program Language” 370. The representative word 370 indicates a representative vocabulary expressed in synthetic consideration of the related attribute and the query in an upper layer. The representative word 370 may also indicate a representative vocabulary expressed in synthetic consideration of the related attribute and the related attribute in the upper layer. In addition, the representative word 370 may be referred to as a vocabulary representatively indicating the related attribute in the current layer, and in this case, the related attribute may be replaced by the representative word 370. For example, “Program Language” may be replaced by “Java Program Language”.

The content classification unit 600 extracts a second content set 352 having a high association with “Java Program Language”, which is {J1, J2, J3, A1, A2, A4, C1, C3, C4, G2, G4}, from the first content set 351. “Coffee” that is another one of the related attributes may be called as a representative word “Java Coffee”, and the content classification unit 600 extracts a second content set 353 having a high association with “Java Coffee”, which is {4}, from the first content set 351. “Island” that is still another one of the related attributes may be called as a representative word “Java Island”, and the content classification unit 600 extracts a second content set 354 having a high association with the “Java Island”, which is {A3}, from the first content set 351.

As described above, by extracting one or more attributes and extracting related attributes from the extracted attribute, starting from the user query, the meaning of the user query can be further conceptualized. In addition, by classifying the content based on the extraction of the related attributes, content that efficiently reflects the contextual information can be searched based on the query conceptualization.

Referring again to FIGS. 3 and 4, the attribute extraction unit 200 extracts attributes 330 for the related attributes, after the content classification is performed with respect to the respective related attributes. For example, if the related attribute is “Program Language” and the representative word 370 is “Java Program Language”, the extracted attributes become “Applet, Tool, Game, Compiler, Software, . . . }. If the related attribute is “coffee” and the representative word 370 is “Java Coffee”, the extracted attributes become “Coffee, Indonesia, Franchise, . . . ” If the related attribute is “Island” and the representative word 370 is “Java Island”, the extracted attributes may become “Island, Indonesia, Volcano, . . . ”

If the attributes 330 are extracted, the related attribute extraction unit 500 extracts related attributes from one or more of the extracted attributes. Here, since the attribute is the attribute of the related attribute, the related attribute becomes the related attribute of the related attribute. For example, the attributes “Applet, Tool, Game, Compiler, Software, . . . ” are extracted with respect to the related attribute “Program Language”, and the related attributes “Applet, Tool, Game, and Compiler” are selected from the extracted attributes 330.

As the related attributes “Applet, Tool, Game, and Compiler” are selected with respect to the related attribute “Program Language”, respective nodes on a general data structure may be generated. The generated nodes may correspond to a third layer as shown in FIG. 3. If the related attributes are selected, the content classification unit 600 classifies the content in accordance with the selected related attributes. In this case, the content classification is attempted from a content set in an upper layer.

For example, with respect to “Applet” that is one of the selected related attributes, the representative word becomes “Java-Applet”, and the content classification unit 600 extracts the third content set having a high association with the related attribute “Applet” from {J1, J2, J3, A1, A2, A4, C1, C3, C4, G2, G4} that is the second content set for “Java Program Language”. For example, the content classification unit 600 extracts {J1, J3, A1, A2} that is the third content set 356, which is judged to have a higher association than a specified threshold value, from {J1, J2, J3, A1, A2, A4, C1, C3, C4, G2, G4}.

As described above, by extracting attributes for a user query and selecting related attributes from the extracted attributes, the user query is materialized, and by extracting attributes for the related attributes and selecting again the related attributes for the extracted attributes, the user query intention is materialized as meaningful conceptual information. Accordingly, by repeating the selection of the related attributes, the query is conceptualized, and a content set automatically classified in accordance with the conceptualization is acquired.

The hierarchical structure information generated in the above-described process as shown in FIG. 3 is stored as contextual association information. If the user inputs the same query or a similar query later, the stored contextual association information is read out to provide the conceptualization information in response to the user query. In addition, even in the case where the user adds or changes the hierarchical structure information, the contextual association information can be continuously updated by updating and storing the hierarchical structure information as shown in FIG. 3.

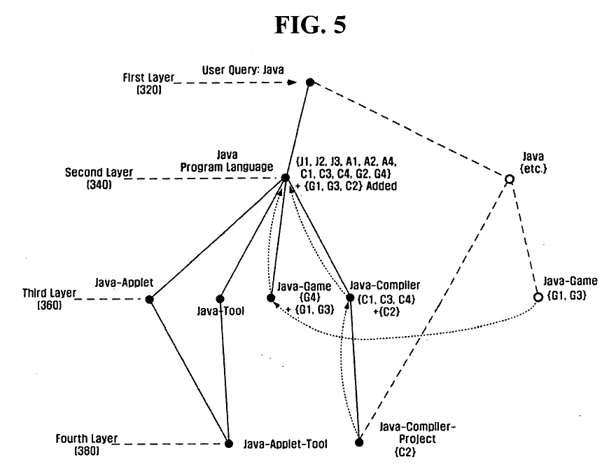

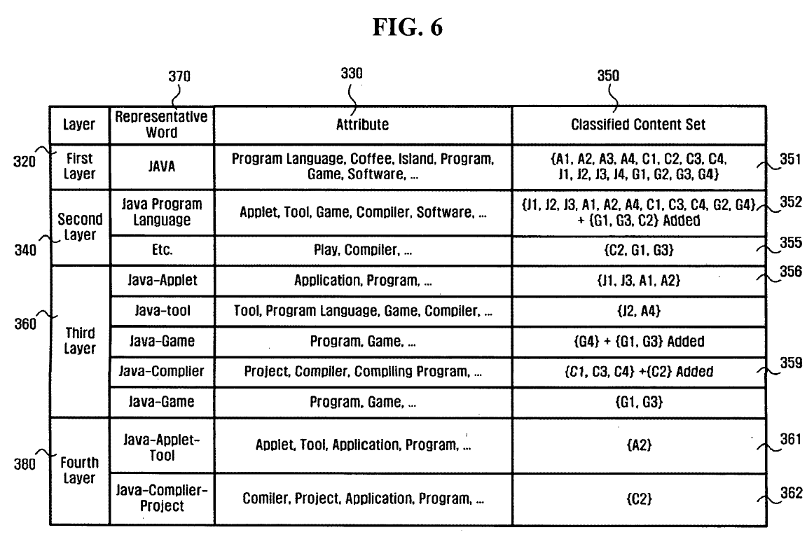

FIG. 5 shows the operation of the system 100 according to another example embodiment of the present invention, and FIG. 6 shows information derived from respective layers shown in FIG. 5. Referring to FIGS. 5 and 6, the system 100 operates basically in the same process as described above with reference to FIGS. 3 and 4, in which a word “Java” is inputted as the user query.

Only operations distinguished from the system as shown in FIGS. 3 and 4 will be described in detail with respect to FIGS. 5 and 6. Also, in the example shown in FIGS. 5 and 6, if “Java” is inputted as the user query, “Program Language”, “Coffee”, and “Island” are selected as the related attributes, and the content is classified in accordance with the selected related attributes. For convenience in explanation, the related attributes “Coffee” and “Island” will be omitted from FIGS. 5 and 6.

If “Java” is inputted as the user query, java-related content is extracted as the first content set 351 that is {A1, A2, A3, A4, C1, C2, C3, C4, J1, J2, J3, J4, G1, G2, G3, G4}, and if the related attribute in the second content set is “Program Language” and the representative word 370 is “Java Program Language”, {A1, A2, A4, C1, C3, C4, G2, G4} is extracted. The other content set (Etc) 355, which is judged to be in association with Java, but has no correlation with the selected related attributes, becomes {C2, G1, G3}.

“Program Language” may be selected as the related attribute, and “Applet”, “Tool”, “Game”, and “Compiler” may be selected as the related attributes after the extraction of the attributes for “Program Language”. The respective representative words for the selected related attributes may be “Java-Applet”, “Java-Tool”, “Java-Game”, and “Java-Compiler”.

The content is classified in accordance with the selected related attributes. In FIGS. 3 and 4, the content is classified into {J1, J3, A1, A2}, {J2, A4}, {G4}, and {C1, C3, C4} as the third content sets. In FIGS. 3 and 4, the third content sets are extracted from {J1, J2, J3, A1, A2, A4, C1, C3, C4, G2, G4} that is the second content set belonging to the upper layer.

In another example embodiment of the present invention, during the content classification, the content set, which is judged not to have correlations with the selected related attributes selected in the upper layer, may be included in the content set of the upper layer. For example, as shown in FIG. 6, a set obtained by adding the second content set 352, in which the related attribute is “Program Language” and the representative word 370 is “Java Program Language”, to the other second content set (Etc) 355, which is judged not to have correlations with the selected related attributes (e.g., “Program Language”, “Coffee”, and “Island”), may be a population.

Accordingly, with respect to “Applet”, “Tool”, “Game”, and “Compiler” that are the selected related attributes in the third layer 360, {J1, J2, J3, A1, A2, A4, C1, C3, C4, G2, G4, G3, C2}, which is the union of the second content set 351 for “Program Language” and the second content set 355 for the others (Etc), may be the population. Accordingly, in the third layer, the content may be classified by the population with respect to the selected related attributes.

For example, if the selected related attribute is “Game” and the representative word is “Java-Game”, {G4} is classified from the second content set 251 for “Program Language”, and {G1, G3} is classified from the second content set 355 for the others (Etc). Accordingly, with respect to the selected related attribute “Game”, the third content set of {G4, G1, G3}, which includes {G4} and {G1, G3}, is classified. In addition, the second content set of “Java Program Language” in the upper layer for “Java-Game” may be changed to {J1, J2, J3, A1, A2, A4, C1, C3, C4, G2, G4, G1, G3}.

If the selected related attributes is “Project” and the representative word 370 is “Java-Compiler-Project”, the content is classified from the third content set in the upper layer {C1, C3, C4} and the other content set (Etc) (C2, C1, C3). In this example, the content set 362 that is judged to be in association with the selected related attribute “Project” is {C2}. Accordingly, if the representative word 370 is “Java-Compiler-Project” and the content set is {C2}, the third content set 359 for “Java-Compiler” in the upper layer is changed to {C1, C3, C4, C2} which includes {C1, C3, C4} and {C2}. In addition, the second content set for “Java Program Language” that is the upper layer of “Java-Compiler” is changed to {J1, J2, J3, A1, A2, A4, C1, C3, C4, G2, G4, G1, G3, C2}.

As described above, by including the content that is judged to have no correlation in the content set included in the upper layer and classifying the content by analyzing the correlations with the selected related attributes, a latticed content classification, rather than the hierarchical content classification, can be achieved. Accordingly, even the content set that is classified to have no correlation can be classified as the content having the correlation by conceptualizing the query in accordance with the selected related attribute. Thus, even if the initial content classification goes wrong, the accuracy of the content classification can be heightened through the gradual conceptualization process.

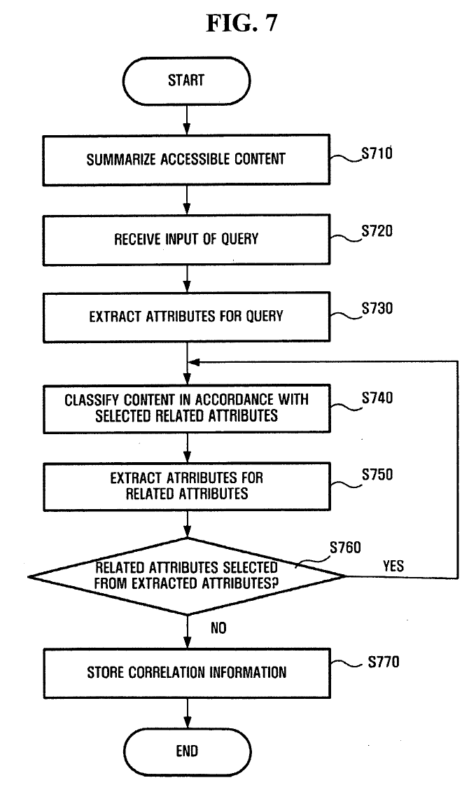

FIG. 7 is a flowchart of a process for contextual association discovery to conceptualize a user query according to an example embodiment of the present invention. Accessible content is first summarized at block S710. Content summarization refers to a structural summarization of the content. The content summarization is structurally analyzed through extraction of a syntax included in the content through the content summarization unit 200.

A user query is inputted from a user through a user interface at block S720. The user inputs a user query composed of a word or a set of words related to the subject to be searched, and the user input unit 110 receives the input query. Attributes for the input query are extracted, and related attributes are selected among the extracted attributes at block S730. The attribute extraction unit 300 arranges the attributes for the query by extracting definition information of the query from the commonsense providing unit 400. The attribute extraction unit 300 may also extract one or more attributes from content having a high association with the query based on the content summarization.

The attributes are extracted, and one or more related attributes are selected from the extracted attributes. The related attributes may be optionally selected by the user or the attributes having high correlations among the extracted attributes may be selected as the related attributes. The order of correlation may be generated through a numerical presentation of the correlation in accordance with index information or priority order information appearing between the extracted attributes and content summarization information. The order of correlation may also be generated by accessing accessible content based on the extracted attributes and making a numerical representation of the correlation of the extracted attributes.

If the related attributes are selected, the content is classified in accordance with the selected related attributes at block S740. The content is classified into content sets for the respective related attributes by classifying the content judged to have a high association into one set. For example, the correlation is numerically represented by functionalizing the number of simultaneous appearances of the respective related attributes and the query, the distance between the respective related attributes and the query in the content, and the like, and if the numerically represented correlation is higher than a threshold value, the correlation is included in the content set for the corresponding related attributes. If the content classification is completed, the content list is displayed on the output unit 550 in accordance with the content classification.

After the content classification, the attributes for the respective related attributes are extracted at block S750. The content is classified in accordance with the respective related attributes, and one or more attributes are extracted from the classified content set. Accordingly, one or more attributes are arranged for the respective related attributes.

Whether the related attributes are selected is judged with respect to the extracted attributes at block S760. If the conceptualization of the query input by the user is substantially meaningful or if the content that reflects the user query intention is acquired, no further process is performed. Accordingly, the related attributes and the classified content are arranged up to the current stage, and are stored as the correlation information at block S770.

If the related attributes are selected for the extracted attributes, the content can be reclassified in accordance with the selected related attribute at block S740. After the content classification, the attributes are extracted again in accordance with the classified content at block S750. Accordingly, by repeating the above-described blocks S760, S740, and S750, the conceptualization for gradually materializing the query can be achieved. Accordingly, if the conceptualization of the query input by the user is substantially meaningful or if the content that concretely reflects the user query intention is acquired, the correlation information up to the current stage is stored, and the process ends at block S770.

As described above, according to aspects of the present invention, the user query intention can be concretely conceptualized by using the attributes extracted from the content, considering the query inputted by the user as a start point. Also, by classifying the content in accordance with the query conceptualization, the content containing information to be obtained can be effectively acquired. In addition, the correlation information is stored, and if the user intends to access the content with a similar query later, the related attributes and the content classification having a high association with the user query intention can be provided. Further, through the query input and the related attribute selection, the user can characterize his/her search intention or concretely conceptualize the query.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, a content retrieval unit may be provided to retrieve content having attributes matching the selected attributes and/or to provide the content or a list of the content to the user or to a client device. Accordingly, it is intended, therefore, that the present invention not be limited to the various example embodiments disclosed, but that the present invention includes all embodiments falling within the scope of the appended claims.

What is claimed is:

1. A system to conceptualize a user query via contextual association discovery, the system comprising:
a user input unit to receive an input of a user query from a user;
an attribute extraction unit to extract one or more attributes indicative of the meaning of the input query;
a related attribute selection unit to select one or more related attributes from the extracted attributes; and
a content classification unit to classify specified content based on the selected related attributes and the query.

2. The system of claim 1, further comprising a document content summarization unit to summarize the accessible content and to provide the summarized content to the attribute extraction unit.

3. The system of claim 2, further comprising a content collection unit to collect the accessible content through a wired or wireless network.

4. The system of claim 1, further comprising:
a commonsense providing unit to provide to the attribute extraction unit dictionary information for the input query or defined meaning information;
wherein the attribute extraction unit receives the dictionary information for the input query or the defined meaning information from the commonsense providing unit, and extracts the one or more attributes and extracts the one or more attributes based on the dictionary information or the defined meaning information.

5. The system of claim 1, wherein the attribute extraction unit extracts the one or more attributes based on the query from a content set related to the input query.

6. The system of claim 1, wherein the related attribute selection unit selects the one or more related attributes from the one or more extracted attributes, or automatically selects the one or more related attributes based on the order of correlation among the one or more extracted attributes, via a user input.

7. The system of claim 1, wherein the content classification unit extracts and classifies the content from content sets classified in an upper layer based on the correlation with the selected related attributes.

8. The system of claim 1, wherein the content classification unit extracts and classifies the content from a union of a content set classified in an upper layer based on a correlation with the selected related attributes and a content set having no correlation with the related attributes of the query.

9. The system of claim 1, further comprising a contextual association storage unit to store contextual association information provided with the query, the selected related attributes, and content classification information based on the selected related attributes.

10. The system of claim 1, further comprising an output unit to output an arrangement of the attributes extracted by the attribute extraction unit or a content list classified by the content classification unit.

11. A method of contextual association discovery to conceptualize a user query, comprising:
receiving an input of a user query from a user;
extracting one or more attributes indicative of a meaning of the input query;
selecting one or more related attributes from the extracted attributes; and
classifying specified content based on the selected related attributes and the query.

12. The method of claim 11, further comprising:
repeating the extracting of the one of more attributes, the selecting of the one or more related attributes, and the classifying of the specified content;
wherein the extracting of the one or more attributes comprises extracting the one or more attributes for the related attributes from classified content sets; and
wherein the selecting of the one or more related attributes comprises selecting the related attributes from the one or more attributes extracted from the classified content sets.

13. The method of claim 11, further comprising summarizing content information of the assessable content.

14. The method of claim 13, further comprising collecting the accessible content through a wired or wireless network.

15. The method of claim 11, wherein the extracting of the one or more attributes comprises:
receiving dictionary information for the input query or defined meaning information; and
extracting the one or more attributes.

16. The method of claim 11, wherein the extracting of the one or more attributes comprises extracting the one or more attributes based on a correlation between the query and content sets related to the input query.

17. The method of claim 11, wherein the selecting of the one or more related attributes comprises selecting the one or more related attributes from the one or more extracted attributes, or automatically selecting the one or more related attributes based on the order of correlation among the one or more extracted attributes, through a user input.

18. The method of claim 11, wherein the classifying of the specified content comprises extracting and classifying the content from content sets classified in an upper layer based on the correlation with the selected related attributes.

19. The method of claim 11, wherein the classifying of the specified content comprises extracting and classifying the content from a union of a content set classified in an upper layer based a correlation with the selected related attributes and a content set having no correlation with the related attributes of the query.

20. The method of claim 11, further comprising storing contextual association information provided with the query, the selected related attributes, and content classification information based on the selected related attributes.

21. The method of claim 11, further comprising:
outputting an arrangement of the extracted attributes or a content list classified through the content classification.

22. A method of searching content, the method comprising:
receiving an input query from a client device;
extracting one or more attributes from the query indicative of a meaning of the query;
selecting one or more related attributes from the extracted attributes;
retrieving content having attributes matching the one or more selected attributes; and
providing the retrieved content to the user.

23. The method of claim 22, further comprising:
storing the one or more selected attributes; and
retrieving the stored attributes and retrieving the content based on the stored attributes if the input query is received from the client device again.

24. An apparatus to provide content to a user, the apparatus comprising:
an input unit to receive a query from a client device;
an attribute extraction unit to extract one or more attributes from the query indicative of a meaning of the query;
a related attribute selection unit to select one or more attributes from the extracted attributes; and
a content retrieval unit to retrieve content having attributes matching the one or more selected attributes.

25. The apparatus of claim 24, further comprising:
an output unit to provide the retrieved content, or a list of the retrieved content, to the input unit.

26. The apparatus of claim 24, further comprising:
a storage unit to store the content.

27. The apparatus of claim 24, further comprising:
a storage unit to store the selected attributes;
wherein, if the input unit receives the query from the user again, the content retrieval unit retrieves the stored selected attributes and retrieves the content based on the stored selected attributes.
